(19) United States
(12) Patent Application Publication
(10) Pub. No.: US 2021/0016516 A1
(43) Pub. Date: Jan. 21, 2021

(54) Welder Hose and Wiring Cable Assembly and Method with Integral Connectors and Handle for Quick Replacement

(71) Applicants: Signal Ventures, Inc. d/b/a Polyvance, Rainsville, AL (US); iCONN Systems, LLC, Lombard, IL (US)

(72) Inventors: Scott Edwin Bixler, Rising Fawn, GA (US); Robert Anthony Czyz, Schaumburg, IL (US)

(21) Appl. No.: 16/931,052

(22) Filed: Jul. 16, 2020

Related U.S. Application Data
(60) Provisional application No. 62/875,290, filed on Jul. 17, 2019.

(51) Int. Cl. B29C 65/30; B29C 65/10; B29C 65/00

(52) U.S. Cl. CPC B29C 65/30; B29C 66/9141; B29C 66/00141; B29C 65/10

(57) ABSTRACT

A plastic welder comprising a control unit comprising a bulkhead assembly, a torch assembly comprising a torch hybrid connector, and a hybrid cable hose assembly comprising a hybrid cable hose including a threaded portion, a first overmolded portion, a second overmolded portion, wherein the torch assembly is removably attachable to the bulkhead assembly of the control unit by the hybrid cable hose assembly.

### CROSS REFERENCE TO RELATED APPLICATION

The present application claims the benefit of U.S. Provisional Application Ser. No. 62/875,290, filed Jul. 17, 2019, entitled “Welder Hose and Wiring Cable Assembly with Integral Connectors and Handle for Quick Replacement.” The contents of above-listed application are incorporated herein by reference in their entirety.

### FIELD OF DISCLOSURE

The present subject matter relates to plastic welder methods and devices, and more particularly to a hose and wiring cable assembly that is easily replaceable.

### BACKGROUND

Plastic welders are used to repair broken or cracked equipment often by fusing two or more pieces of plastic. This technology is particularly useful in the automotive industry to repair vehicle bumpers or other plastic components. Broken or cracked plastic components may be fused together using heat. Also, a plastic weld rod may be applied to heated plastic in order to strengthen a cracked workpiece or to join two workpieces together. Common automotive plastics that are compatible with plastic welding includes, but is not limited to: polyurethane (TPU), polypropylene, acrylonitrile butadiene styrene (ABS), polyethylene, thermoplastic olefin (TPO), nylon, polycarbonate, polyphenylene ether and polystyrene (PPE+PS), polybutylene terephthalate, polyethylene terephthalate (PET), acrylonitrile styrene acrylate (ASA), NORYL GTX™ (polyamide (PA) and modified polyphenylene ether polymer (PPE)), polyoxymethylene (POM or Delrin®), and thermoplastic acrylic-polyvinyl chloride (Kydex®).

Current plastic welder designs use air hoses made of vinyl or silicone with power cables running therethrough and are prone to failures. Such air hoses and wiring cables are not easily replaced by users of such systems in the field. This lack of easy replacement leads to costly equipment downtime with the added inconvenience of scheduling and waiting for a skilled technician to fix the machine on site.

### SUMMARY

According to one aspect, a plastic welder comprises a control unit comprising a bulkhead assembly, a torch assembly comprising a torch hybrid connector, and a hybrid cable hose assembly comprising a hybrid cable hose including a threaded portion, a first overmolded portion, a second overmolded portion, wherein the torch assembly is removably attachable to the bulkhead assembly of the control unit by the hybrid cable hose assembly.

According to another aspect, a method of assembling a plastic welder includes attaching a hybrid cable hose assembly to a control unit, wherein the control unit comprises a bulkhead assembly, and wherein the hybrid cable hose assembly comprises a hybrid cable hose including a threaded portion, a first overmolded portion, and a second overmolded portion, and attaching a torch assembly to the hybrid cable hose assembly, wherein the torch assembly comprises a torch hybrid connector, and wherein the torch assembly is removably attachable to the bulkhead assembly of the control unit by the hybrid cable hose assembly.

Other aspects and advantages will become apparent upon consideration of the following detailed description and the attached drawings wherein like numerals designate like structures throughout the specification.

### BRIEF DESCRIPTION OF THE DRAWINGS

FIG. 1 comprises a perspective view of a plastic welder system;

FIG. 2 comprises a perspective view of a control unit of a plastic welder system together with an airless welder system;

FIG. 3 comprises a perspective view of a plastic welder system of the present disclosure having a torch assembly and a hybrid cable hose assembly;

FIG. 4 is an isometric view of an embodiment of the torch assembly of the plastic welder system;

FIG. 5 is an exploded isometric view of the embodiment of the torch assembly of FIG. 4;

FIG. 6 is a fragmentary exploded side elevational view of the hybrid cable hose assembly of FIG. 4;

FIG. 7 is a fragmentary side elevational view of the assembled hybrid cable hose assembly of FIG. 4;

FIG. 8 is a fragmentary sectional view of the hybrid cable hose assembly taken generally along lines 8-8 of FIG. 7;

FIG. 9 is an enlarged fragmentary view of the portion of the hybrid cable hose assembly designated by the view line A of FIG. 8;

FIG. 10 is an enlarged fragmentary view of the portion of the hybrid cable hose assembly designated by the view line B of FIG. 8;

FIG. 11 is a perspective view of the torch handle assembly and hybrid cable hose assembly of FIG. 3;

FIG. 12 is a perspective view of the hybrid cable hose assembly of FIG. 3;

FIG. 13A is an end perspective view of a torch hybrid connector;.

FIG. 13B is a side elevational view of the torch hybrid connector of FIG. 13A;

FIG. 14A is an end perspective view of a bulkhead assembly;

FIG. 14B is a side perspective view of the bulkhead assembly of FIG. 14A;

FIG. 15 is an isometric view taken from one side of an alternative embodiment of the torch hybrid connector, hybrid cable hose assembly, and the bulkhead assembly; and

FIG. 16 is an isometric view taken from an opposite side of the alternative embodiment of FIG. 15.

### DETAILED DESCRIPTION

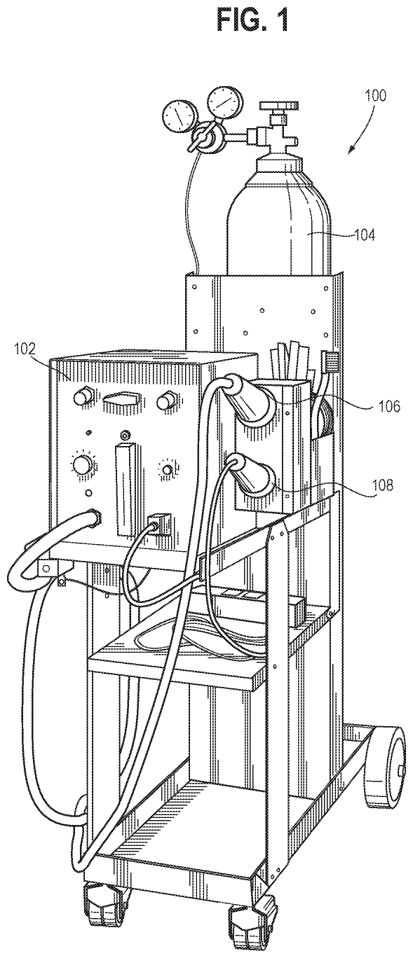

FIG. 1 illustrates a plastic welder system 100 having a control unit 102, a shield gas source 104, a main torch assembly 106, and an airless torch assembly 108. The shield gas source 104 could be a nitrogen shield gas source such as a nitrogen tank or a membrane system. The plastic welder could also use air in place of an inert shield gas.

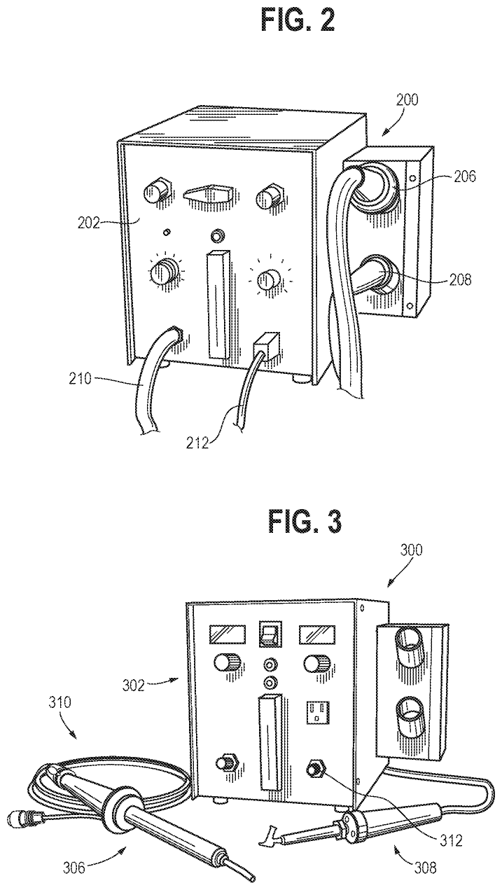

FIG. 2 illustrates a plastic welder system 200 with a main torch assembly 206 connected to a control unit 202 by a hose assembly 210. An airless torch assembly 208 is connected to the control unit 202 by a cable 212. The hose assembly 210 is hard-wired to both the main torch assembly 206 and the control unit 202. This hose assembly 210 may become damaged, possibly resulting in loss of air/nitrogen pressure, which can lead to an overheated condition in the torch handle. Over heating can permanently damage the torch, the heating element, the handle, or the torch handle receptacle. Replacing the hose or handle requires the welder system to be disassembled and retrofitted with a new hose assembly. This type of repair may be a time consuming, expensive, and cumbersome task even for a skilled repairperson. Further, the equipment downtime associated with such a failure may have disadvantageous financial repercussions on an automotive repair facility that uses such a plastic welder system.

FIG. 3 illustrates a plastic welder system 300 of the present disclosure having a control unit 302 that operates preferably with a nitrogen source (not shown). The control unit 302 includes a control panel with a control knob, a digital display, a flow meter, and indication lights to allow a user to operate the main torch assembly 306 of the nitrogen welder. The control unit also includes a further control knob, a further digital display, further indication lights, and a power outlet to allow a user to operate the airless torch assembly 308 of the airless welder.

Air/nitrogen flow to the main torch assembly 306 is important to enable a user of the plastic welder system to achieve a high quality repair. As is known, air is approximately 80% nitrogen and 20% oxygen. In certain circumstances oxygen in the air causes problems when operating a plastic welder torch using an airless or air-based system. When one operates an airless torch 308 in ambient air or a main torch assembly 306 with forced air, the plastic may oxidize or burn, which will result in a weakened workpiece. Consequently, nitrogen may be used as an inert shield gas during plastic welding to achieve optimum results. Welding with a source of forced hot nitrogen gas flushes the oxygen out of the weld zone. The plastic melts cleanly with no contamination, no smoke, no fire, and no oxidation. The melted plastics can then fuse together with no contamination for maximum strength.

The main torch assembly 306 is removably attachable to the bulkhead assembly 312 of the control unit 302 by a hybrid cable hose assembly 310. The hybrid cable hose and overmolded portions are durable and made of thermoplastic polyurethane (TPU). The hybrid cable hose is an integrated cable containing an air/nitrogen hose, power cables (hot, neutral, and ground) for the heating element, and communication wires for temperature control.

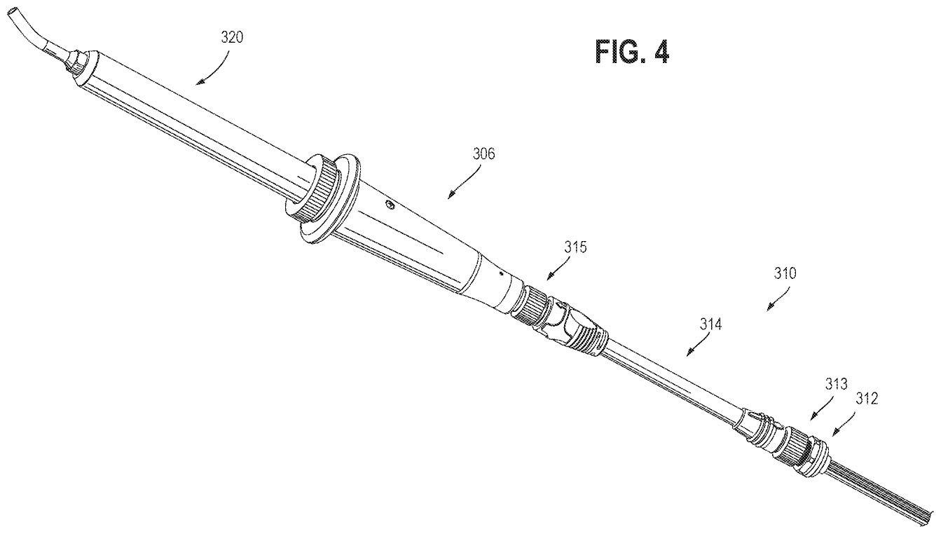

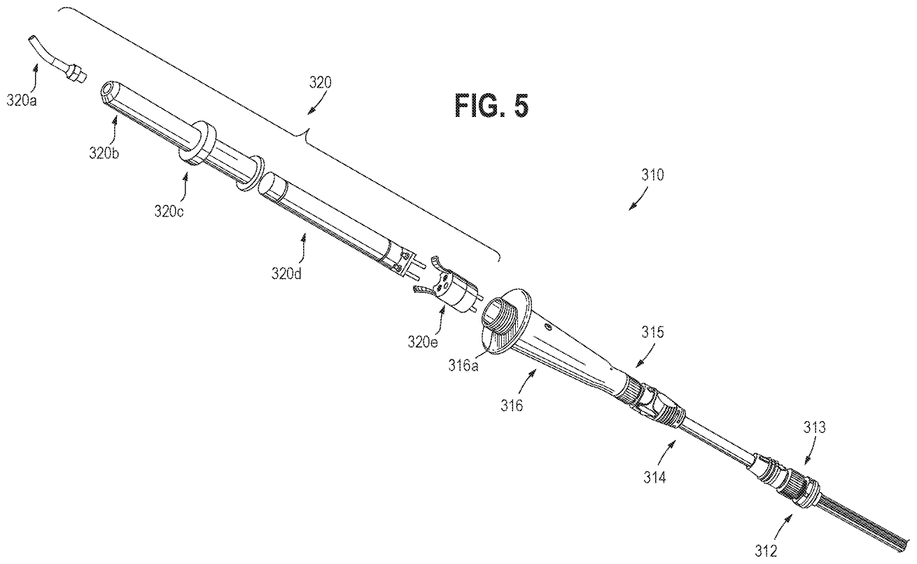

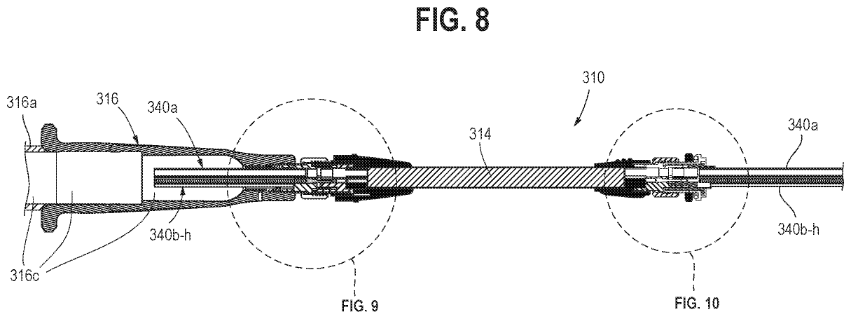

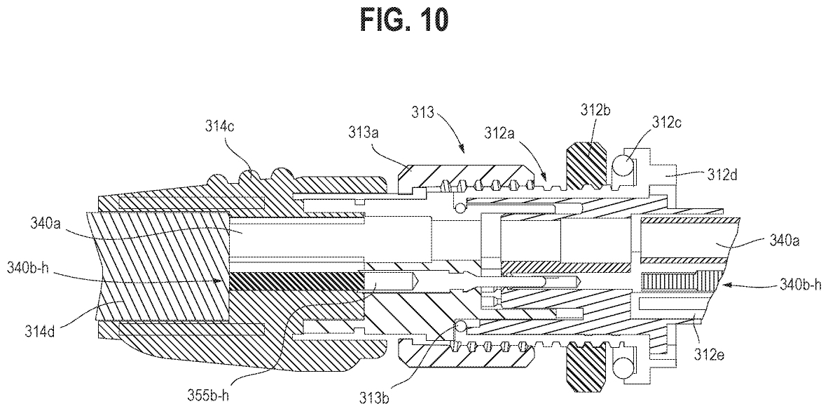

Referring to FIGS. 4 and 5, the bulkhead assembly 312 has a threaded portion that is attached to the bulkhead hybrid connector 313 of the hybrid cable hose assembly 310 and is sealed by an O-ring 313b (not shown in FIGS. 4 and 5 but visible in FIGS. 10 and 12). The main torch assembly 306 comprises a torch handle 316 and an upper torch portion 320. The upper torch portion 320 comprises a welding tip 320a, a stainless steel barrel 320b, a brass nut 320c, a heating element 320d, and a receptacle 320e. The brass nut 320c holds the upper torch portion 320 together when tightened to the threated stainless steel insert 316a of the torch handle 316. Nitrogen travels from the pressurized nitrogen source 104, through the air/nitrogen hose 340a (seen in FIGS. 8-11, 13B-14B), into the torch handle 316, past the heating element 320d, out of the welding tip 320a, and contacts the workpiece (not shown) to melt the plastic in a controlled manner that avoids unwanted oxidation and burning.

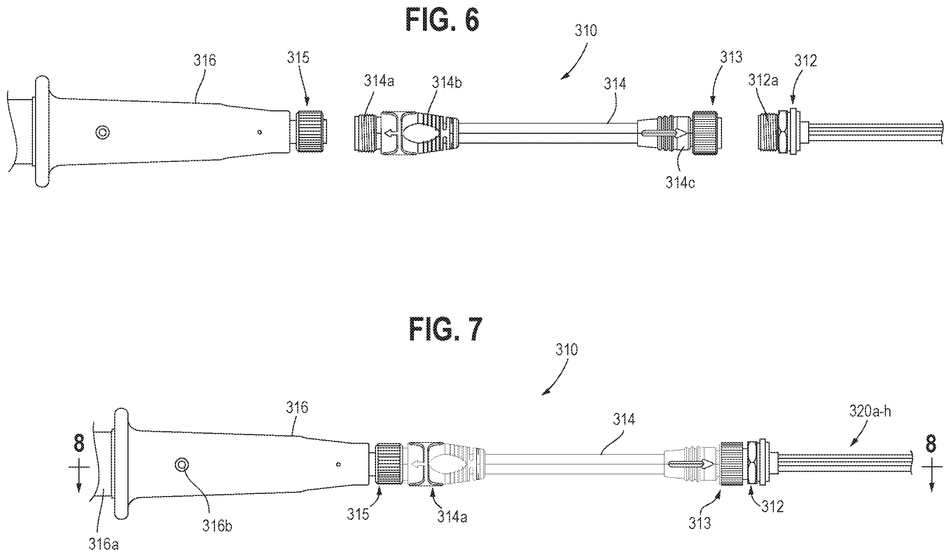

Referring next to FIGS. 6, 7, and 8, a bulkhead hybrid connector 313 is used to attach the bulkhead assembly 312 to the hybrid cable hose 314. The hybrid cable hose assembly 310 includes a hybrid cable hose 314 having a threaded portion 314a, a first overmolded portion 314b, and a second overmolded portion 314c. The torch hybrid connector 315 is used to attach the threaded portion 314a of the hybrid cable hose 314 to the torch handle 316. Cable hose bundles 340a-340h extend to and through the bulkhead assembly 312, the hybrid cable hose 314, and the torch 316 and are connected via electrical connectors (having male contacts and female portions) in the bulkhead hybrid connector 313 and the torch hybrid connector 315. The torch handle 316 includes a stainless steel threaded insert 316a and a countersunk screw hole 316b for retaining the heating element 320d and receptacle 320e. The cable hose bundles 340a-340h comprise an air/nitrogen hose 340a, power cables 340b-340d, and communication wires 340e-340h, respectively.

As seen in FIG. 8, the air/nitrogen hose 340a, the power cables 340b-340d, and communication wires 340e-340h are shown. The torch handle 316 includes a cavity 316c for wire connections, the receptacle, a thermal sensor such as a thermocouple, and a heating element (not shown).

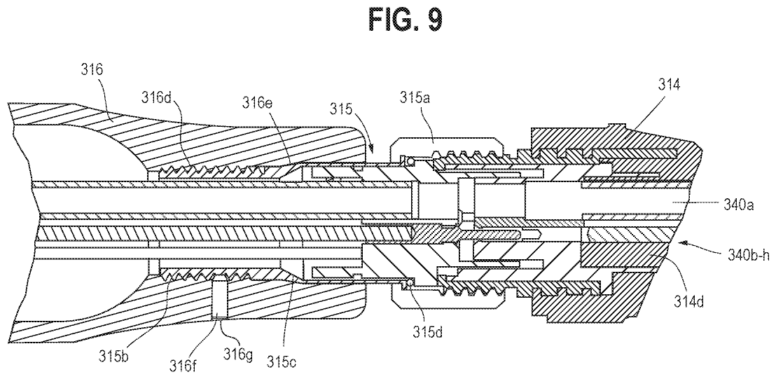

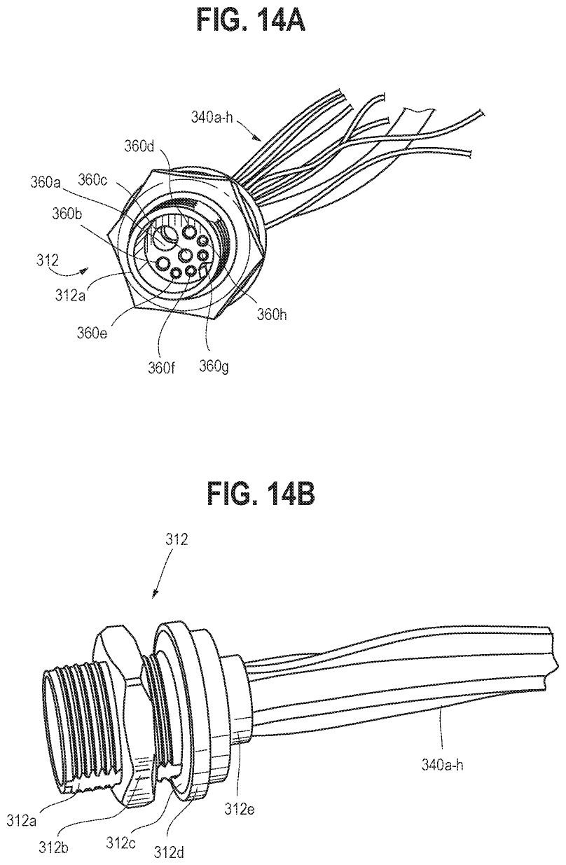

Referring to FIGS. 9 and 10, the torch hybrid connecter 315 includes a knurled nut 315a, a threaded portion 315b, a shoulder 315c, and an O-ring 315d. The torch handle 316 includes a threaded portion 316d, a tapered portion 316e, and a set screw 316f. The set screw 316f is disposed in the set screw hole 316g and engages the threaded portion 315b of the torch hybrid connector 315. A hybrid cable hose sheath 314d covers and protects the cable hose bundles 340a-340h. Male contacts 355b-355h of the bulkhead hybrid connector 313 engage openings 360b-360h (FIG. 14A) of the female portion of the bulkhead assembly 312. The air or nitrogen pressure is sealed by the O-ring 313b.

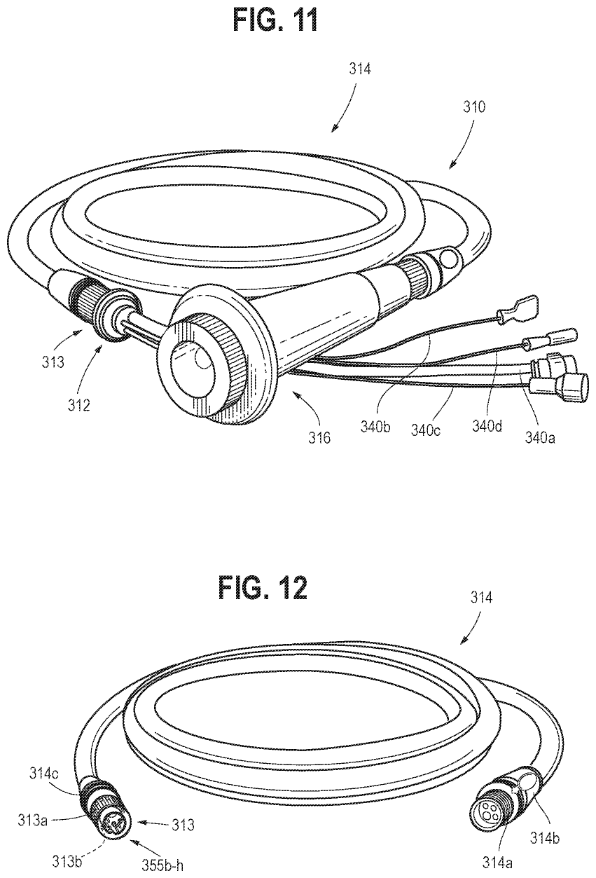

FIGS. 11 and 12 illustrate the hybrid cable hose assembly 310 and the hybrid cable hose 314, respectively. The hybrid cable hose assembly 310 includes a hybrid cable hose 314 having a threaded portion 314a, a first overmolded portion 314b, a second overmolded portion 314c, and a bulkhead hybrid connector 313 having a knurled nut 313a. The bulkhead hybrid connector 313 has a plurality of male contacts that join the plurality of power cables and communication wires 340b-340h and an air/nitrogen port 360a that joins the air/nitrogen hoses.

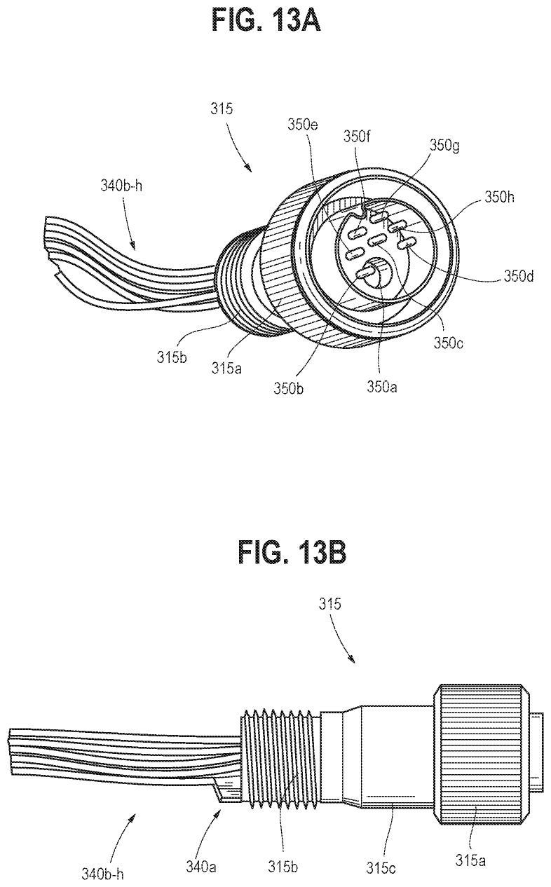

As shown in FIGS. 13A and 13B, the torch hybrid connector 315 is a male fitting (with a plurality of male contacts 350b-h) that joins the torch handle 316 to the hybrid cable hose assembly 310. The air/nitrogen line 340a and plurality of wires including power cables 340b-340d and communication wires 340e-340h are contained within and run through the bulkhead assembly 312, the hybrid cable hose assembly 310, and the torch hybrid connector 315.

Both the bulkhead hybrid connector 313 and the torch hybrid connector 315 have a series of male contacts that join the female portions of the hybrid cable hose 314 and the bulkhead assembly 312. The male contacts of the bulkhead hybrid connector (not shown) are inserted into the openings 360b-360h of the female portion of the bulkhead assembly 312 join the power cables and communication wires. The black wire 340b is hot, the white wire 340c is neutral, and the green wire 340d is ground. The blue, purple, yellow, and red wires 340e-340h are used to provide communication to a temperature sensor. The air/nitrogen line is inserted into the air/nitrogen port 360a of the bulkhead assembly 312.

FIGS. 14A and 14B illustrate an end perspective view and a side view, respectively, of the bulkhead assembly 312. The threaded portion 312a engages the knurled nut 313a of the bulkhead hybrid connector 313. The jam nut 312b is used to mount the bulkhead assembly 312 to the control unit 302. The control unit (not shown) sits in a gap between the jam nut 312b and an O-ring 312c disposed on the bulkhead fitting 312d. A bulkhead cable hose sheath 312e covers the air/nitrogen hose 340a, the power cables 340b-340d, and the communication wires 340e-340h.

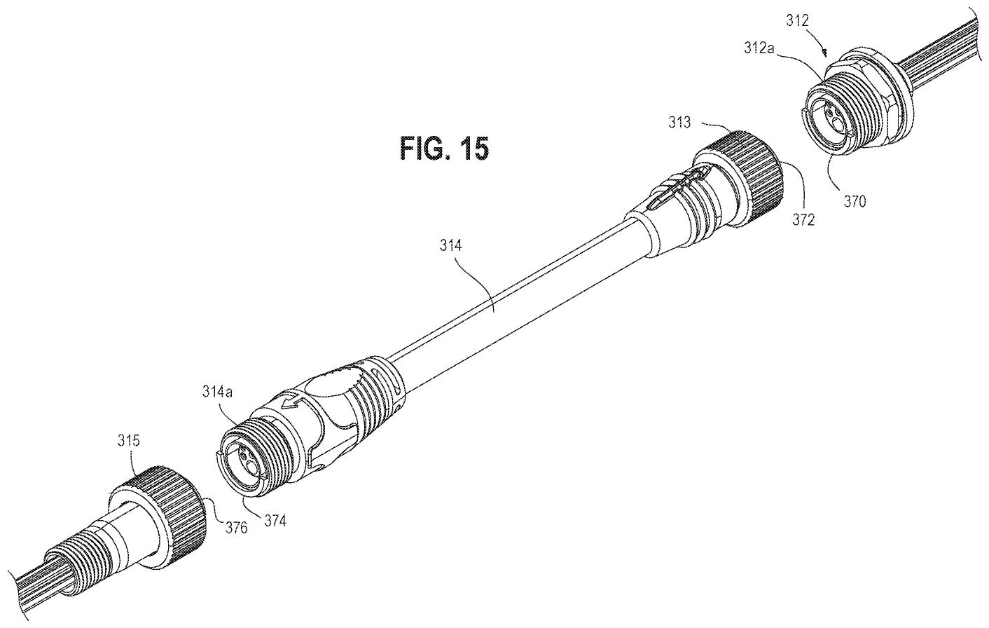

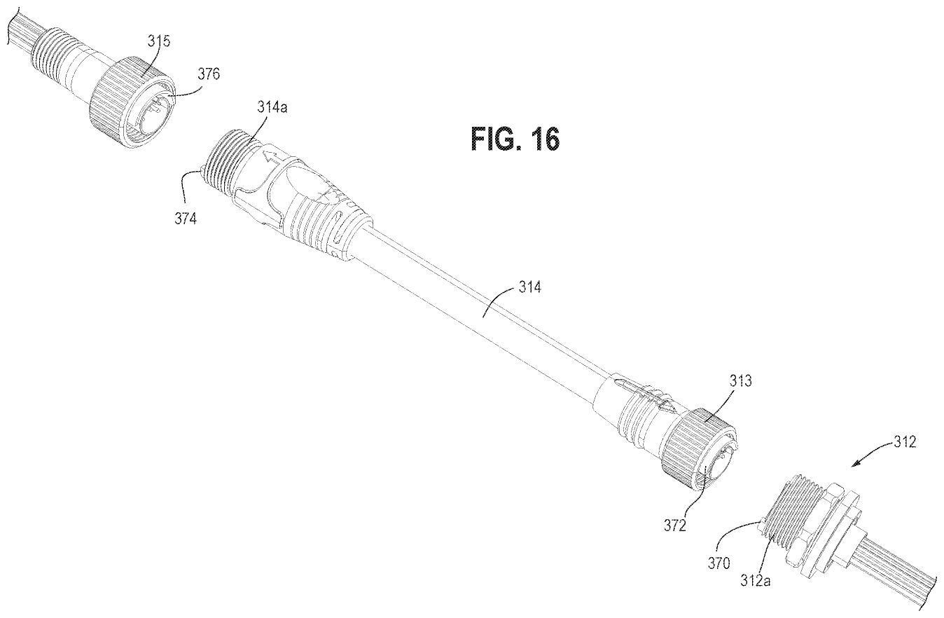

FIGS. 15 and 16 illustrate an alternative embodiment of the torch hybrid connector, hybrid cable hose assembly and the bulkhead assembly. As previously discussed, the bulkhead hybrid connector 313 is used to attach the bulkhead assembly 312 to the hybrid cable hose 314. In an embodiment, the bulkhead assembly 312 includes female electrical connectors disposed within the threaded portion 312a of the bulkhead assembly 312. The threaded portion 312a of the bulkhead assembly 312 includes a bulkhead assembly flange 370 located at a distal end of the threaded portion 312a, wherein the bulkhead assembly flange 370 may guide the connection of the bulkhead hybrid connector 313 and the bulkhead assembly 312. Likewise, the bulkhead hybrid connector 313 includes male electrical connectors and a bulkhead hybrid connector flange 372 located at a distal end of the bulkhead connector 313, wherein the bulkhead hybrid connector flange 372 may guide the connection of the bulkhead hybrid connector 313 and the bulkhead assembly 312. In an embodiment, the bulkhead assembly flange 370 and the bulkhead hybrid connector flange 372 are shaped so as to create a ring shape around the electrical connectors when the bulkhead assembly 312 and bulkhead hybrid connector 313 are connected. Alignment of the bulkhead hybrid connector flange 372 and the bulkhead assembly flange 370 allows the male contacts of the bulkhead hybrid connector 313 to engage openings of the female portion of the bulkhead assembly 312 in the proper assembly orientation minimizing the possibility of damage of the electrical connectors during connection. Once connected, the bulkhead hybrid connector flange 372 and the bulkhead assembly flange 370 prevent relative rotation of the bulkhead hybrid connector 313 and the bulkhead assembly 312, thereby preventing the damage of the electrical connectors of the bulkhead hybrid connector 313 and the bulkhead assembly 312 during use. If the bulkhead connector flange 372 and the bulkhead assembly flange 370 are not aligned in the proper assembly orientation, the male contacts of the bulkhead hybrid connector 313 cannot engage openings of the female portion of the bulkhead assembly 312. In a preferred embodiment, the bulkhead assembly flange 370 is a half-ring shape, and the bulkhead hybrid connector flange 372 is a half-ring shape.

Furthermore, the threaded portion 314a of the hybrid cable hose 314 includes female electrical connectors disposed within the threaded portion 314a of the hybrid cable hose 314. The threaded portion 314a of the hybrid cable hose 314 includes a hybrid cable hose flange 374 located at a distal end of the threaded portion 314a, wherein the hybrid cable hose flange 374 may guide the connection of the hybrid cable hose 314 and the torch hybrid connector 315. Likewise, the torch hybrid connector 315 includes male electrical connectors and a torch hybrid connector flange 376 located at a distal end of the torch hybrid connector 315, wherein the torch hybrid connector flange 376 may guide the connection of the torch hybrid connector 315 and the hybrid cable hose 314. In an embodiment, the hybrid cable hose flange 374 and the torch hybrid connector flange 376 are shaped so as to create a ring shape around the electrical connectors when the hybrid cable hose 314 and torch hybrid connector 315 are connected. Alignment of the torch hybrid connector flange 376 and the hybrid cable hose flange 374 allows the male contacts of the torch hybrid connector 315 to engage openings of the female portion of the hybrid cable hose 314 in the proper assembly orientation minimizing the possibility of damage of the electrical connectors during connection. Once connected, the torch hybrid connector flange 376 and the hybrid cable hose flange 374 prevent relative rotation of the torch hybrid connector 315 and the hybrid cable hose 314, thereby preventing the damage of the electrical connectors of the torch hybrid connector 315 and the hybrid cable hose 314 during use. If the torch hybrid connector flange 376 and the hybrid cable hose flange 374 are not aligned in the proper assembly orientation, the male contacts of the torch hybrid connector 315 cannot engage openings of the female portion of the hybrid cable hose 314. In a preferred embodiment, the hybrid cable hose flange 374 is a half-ring shape, and the torch hybrid connector flange 376 is a half-ring shape.

### INDUSTRIAL APPLICABILITY

Hybrid cable hose assemblies are durable and can be switched out in a matter of minutes. This results in fewer failures and decreased downtime in the event of a cable hose failure.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A plastic welder, comprising:
a control unit comprising a bulkhead assembly;
a torch assembly comprising a torch hybrid connector; and
a hybrid cable hose assembly comprising a hybrid cable hose including a threaded portion, a first overmolded portion, and a second overmolded portion;
wherein the torch assembly is removably attachable to the bulkhead assembly of the control unit by the hybrid cable hose assembly.

2. The plastic welder of claim 1, wherein the bulkhead assembly further comprises a threaded portion.

3. The plastic welder of claim 2, wherein the hybrid cable hose assembly further comprises a bulkhead hybrid connector, wherein the threaded portion of the bulkhead assembly is attached to the bulkhead hybrid connector.

4. The plastic welder of claim 2, wherein threaded portion of the bulkhead assembly includes a bulkhead assembly flange located at a distal end of the threaded portion of the bulkhead assembly.

5. The plastic welder of claim 3, wherein the bulkhead hybrid connector includes a bulkhead hybrid connector flange located at a distal end of the bulkhead connector.

6. The plastic welder of claim 3, wherein the bulkhead assembly flange and the bulkhead hybrid connector flange allow engagement of the bulkhead hybrid connector and the bulkhead assembly in proper assembly orientation.

7. The plastic welder of claim 1, wherein the torch assembly comprises a torch handle and an upper torch portion.

8. The plastic welder of claim 7, wherein the upper torch portion further comprises a welding tip, a barrel, a nut, a heating element, and a receptable.

9. The plastic welder of claim 8, wherein the barrel is stainless steel, and the nut is brass.

10. The plastic welder of claim 8, wherein the torch handle further includes a threaded stainless steel insert, wherein the nut of the upper torch portion holds the upper torch portion together when tightened to the threated stainless steel insert of the torch handle.

11. The plastic welder of claim 8, wherein the hybrid cable hose further comprises cable hose bundles comprising an air/nitrogen hose, a plurality of power cables for the heating element, and a plurality of communication wires for temperature control.

12. The plastic welder of claim 11, wherein the cable hose bundles extend to and through the bulkhead assembly and the hybrid cable hose, and are connected via electrical connectors in the bulkhead hybrid connector and the torch hybrid connector.

13. The plastic welder of claim 1, wherein the threaded portion of the hybrid cable hose includes a hybrid cable hose flange located at a distal end of the threaded portion.

14. The plastic welder of claim 13, wherein the torch hybrid connector includes a torch hybrid flange located at a distal end of the torch hybrid connector.

15. The plastic welder of claim 14, wherein the hybrid cable hose flange and the torch hybrid connector flange allows engagement of the torch hybrid connector and hybrid cable hose in proper assembly orientation.

16. A method of assembling a plastic welder including the steps of:
attaching a hybrid cable hose assembly to a control unit, wherein the control unit comprises a bulkhead assembly, and wherein the hybrid cable hose assembly comprises a hybrid cable hose including a threaded portion, a first overmolded portion, and a second overmolded portion; and
attaching a torch assembly to the hybrid cable hose assembly, wherein the torch assembly comprises a torch hybrid connector, and wherein the torch assembly is removably attachable to the bulkhead assembly of the control unit by the hybrid cable hose assembly.

17. The method of claim 16, wherein the bulkhead assembly further comprises a threaded portion, and the hybrid cable hose assembly further comprises a bulkhead hybrid connector, wherein the threaded portion of the bulkhead assembly is attached to the bulkhead hybrid connector.

18. The method of claim 17, wherein the threaded portion of the bulkhead assembly includes a bulkhead assembly flange located at a distal end of the threaded portion of the bulkhead assembly, wherein the bulkhead hybrid connector includes a bulkhead hybrid connector flange located at a distal end of the bulkhead connector, and wherein the bulkhead assembly flange and the bulkhead hybrid connector flange allow engagement of the bulkhead hybrid connector and the bulkhead assembly in proper assembly orientation.

19. The method of claim 16, wherein the threaded portion of the hybrid cable hose includes a hybrid cable hose flange located at a distal end of the threaded portion, and wherein the torch hybrid connector includes a torch hybrid connector flange located at a distal end of a torch hybrid connector.

20. The method of claim 19, wherein the hybrid cable hose flange and the torch hybrid connector flange allows engagement of the torch hybrid connector and hybrid cable hose in proper assembly orientation.
